(19) United States
(12) Patent Application Publication
(10) Pub. No.: US 2013/0179791 A1
(43) Pub. Date: Jul. 11, 2013

(54) SYSTEM AND METHOD FOR REAL-TIME DATA IN A GRAPHICAL USER INTERFACE

(71) Applicant: Webotics Inc., Waterloo (CA)

(72) Inventors: Anton POLSKI, Thornhill (CA); Alexan KULBASHIAN, Waterloo (CA)

(73) Assignee: WEBOTICS INC., Waterloo (CA)

(21) Appl. No.: 13/716,624

(22) Filed: Dec. 17, 2012

Related U.S. Application Data
(60) Provisional application No. 61/576,644, filed on Dec. 16, 2011.

(51) Int. Cl. H04L 29/08

(52) U.S. Cl. CPC H04L 67/26
USPC 715/733

(57) ABSTRACT

A system and method for real-time push delivery of updates/changes of database records displayed in user interfaces without the clients requesting such data. The data is provided to the graphical user interface such that when changes occur to the source database origin of the displayed data the client user interfaces that contain the records are updated in real-time by receiving an update signal over the computer network which updates the graphical user interface on the client device to reflect the changes that have occurred to the contained data. In order to achieve real-time connectivity, a channel is created between each of the client computing devices and the communications server and subsequently a session with the application server. Data changes recorded from the application server are pushed to each of the client computers simultaneously via the communication server.

### FIELD

The present disclosure is in the field of Internet communication and more particularly related to push delivery of changes of data that is rendered inside a graphical user interface of a software application. The changes in data are provided via messaging, and presence notification.

### BACKGROUND

Conventional systems for updating data on a graphical user interface, such as, for example, a web page or the like, typically involve a “pull” model in which the client requests new web page data from a server. This approach also generally involves the refreshing of an entire web page or of a frame on a web page. There is a need for improved systems and methods of providing updated data in a graphical user interface.

### SUMMARY

The present disclosure pertains particularly to a system and method for real-time push delivery of updates/changes of database records displayed in user interfaces without the clients requesting such data. More particularly, the present disclosure relates to a method and apparatus for displaying database records, and, in particular, updates/changes in data, within graphical user interfaces running on a plurality of client devices such as web browsers, installed desktop applications or mobile software applications.

The data is provided to the graphical user interface such that when changes occur to the source database origin of the displayed data the client user interfaces that contain the records are updated in real-time by receiving an update signal over the computer network which updates the graphical user interface on the client device to reflect the changes that have occurred to the contained data. The update signal is generated by a data change event that occurs within the software component that implements the database access layer as known in the art. In a particular implementation, the system involves a series of client computers or mobile devices interacting with a web based application server over the Internet network.

In order to achieve real-time connectivity between the application server and the plurality of client devices, one embodiment herein utilizes a communication server employing extensible Messaging and Presence Protocols (“XMPP”). Another embodiment utilizes a communication server socket.io as the transport layer and nowjs as the message brokering and address grouping system. The client connection library (for example, Strophe or socket.io) creates a channel between each of the client computing devices and the communications server and subsequently a session with the application server which is initiated by the application server over the local computer network by way of a message received from the client device over the established communications channel. Once the user session is authenticated, data changes recorded from the application server are pushed from the application server to each of the client computers simultaneously via the communication server. This embodiment alleviates the conventional requirement that Client computers do not actively pull information from the communications server but are rather receptive to data that is being pushed down the existing channel.

Specifically, one embodiment herein claims a computer-implemented method for generation of user interface display elements that allows for data updates to be pushed to the client devices using a computer network and an open communications channel between said client devices

This arrangement allows the user to select the components that make up a particular application, configure the layout of their display and specify the logic that governs their interaction and computations.

At present, there are known systems that use real-time push capabilities on the Internet, but with the demand for quick data availability skyrocketing in the recent years, especially in web pages there is an evident need for a low latency solution to effectively tie database changes to real-time updates on client devices. Presently in order for a web application user to see changes in data a web page needs to be refreshed. This can result in additional bandwidth and creating the unnecessary need to refresh the page in order to know if the data has changed. One issue with the classic Web data access paradigm (known as “pull”) is that it is synchronous: it has the client (browser or mobile application) request data from the server in a synchronous manner. Consequently when a particular client application needs a data update, it has to make a network request to the server explicitly to find out if the data has been modified and obtain its new value. In other words, for every request from a client there is a corresponding reply from a server. When a Web page is visualized, the data contained within it is static on the user's browser and is not updated until a page refresh is made (manual or automatic). There are, however, a growing number of applications that necessitate the visualization of real-time data. Current examples are stock prices from on-line trading sites, betting odds from gambling portals, sports results and messages exchanged through online communities. These are just a few cases of systems which, in order to offer the maximum in usability and quality of user experience, require continual updates of the visualized data in the browser page.

There are several layers to the systems and methods in the present disclosure that are intended to enable the smooth, real-time effect desired.

In one particular embodiment, the overall effect is achieved by the interaction of the update-triggering ORM (Object Relational Mapping) engine, the subscription/delivery mechanism and the volatile storage management classes.

Further details of the systems and methods will be further understood from the Figures and following description.

### BRIEF DESCRIPTION OF THE DRAWINGS

FIG. 1 is the high level System overview of a system for real-time data representation

FIG. 2 is an overview of system components on the server and client side

FIG. 3 is a logical overview of the client operations

FIG. 4 is the flow chart of the record retrieval process

FIG. 5 is the Application Server Operations Flowchart

FIG. 6 Describes how the application server handles the data changes and propagates updates to clients

FIG. 7 Describes the User Interface Update Process

FIG. 8 is a high level overview of the update triggering process.

FIG. 9 is a flowchart outlining an end user request and how it results in a browser tab being “subscribed” to receive update notifications

FIG. 10 is a logical overview of processing stages that result in a update notification payload being constructed that will ultimately be pushed to the visitor's browser

FIG. 11 is the inverse to FIG. 9 and the continuation to FIG. 10, describing how the list of subscribers is notified when data is updated

FIG. 12 is a visitor-to-service request overview diagram that shows the paths a request takes

FIG. 13 is an overview of the client side XMPP update process

FIG. 14 is a high-level diagram of the framework used in the systems and methods herein.

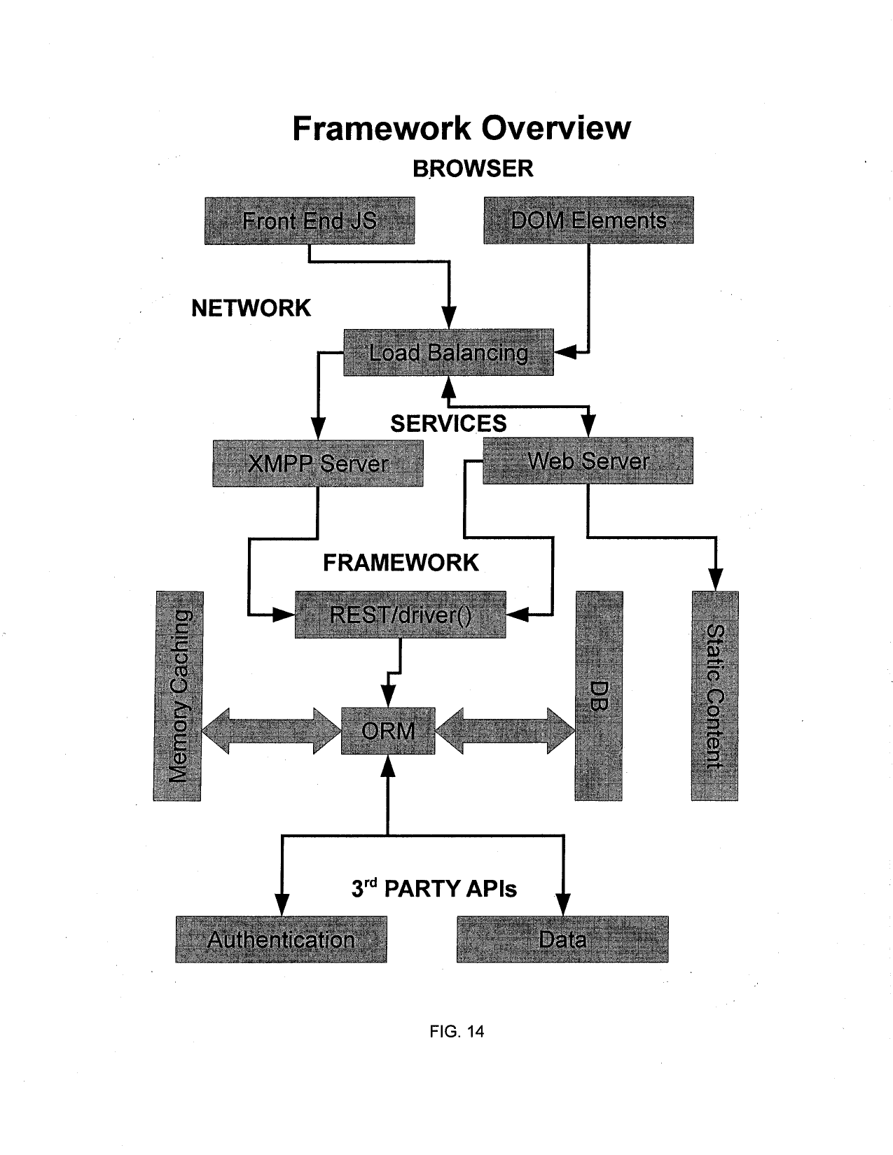

### DETAILED DESCRIPTION OF THE DRAWINGS

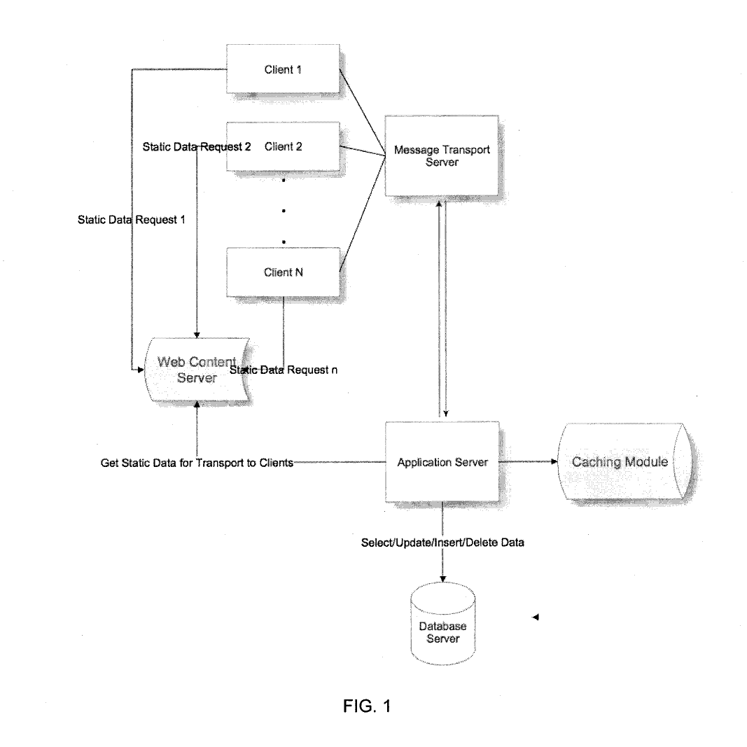

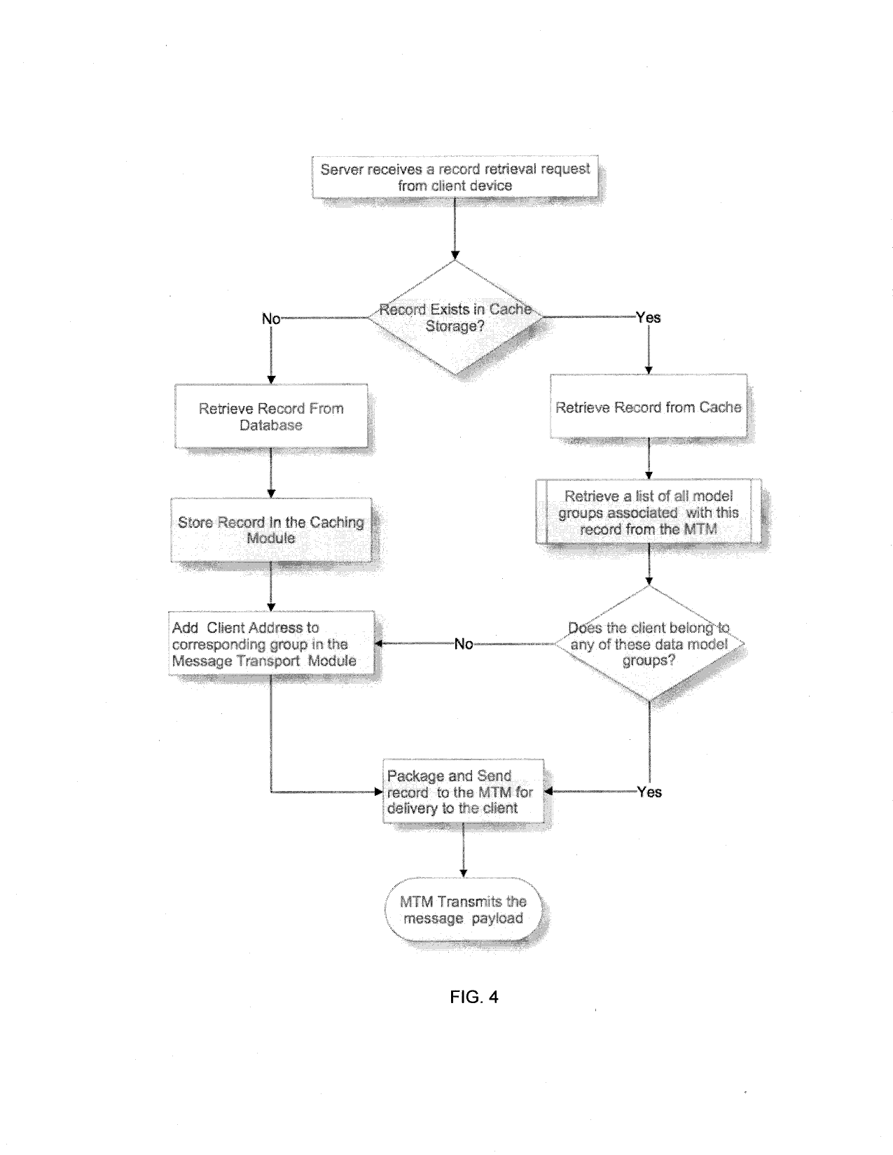

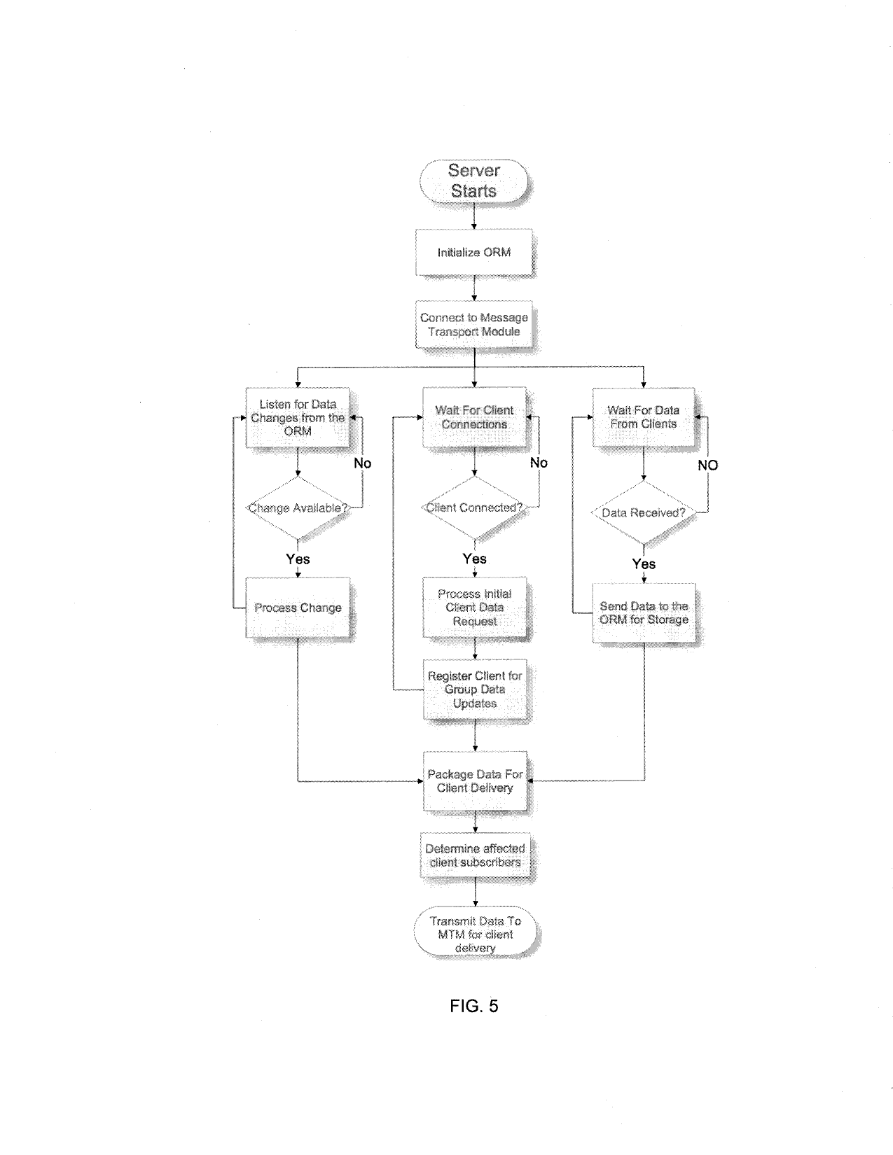

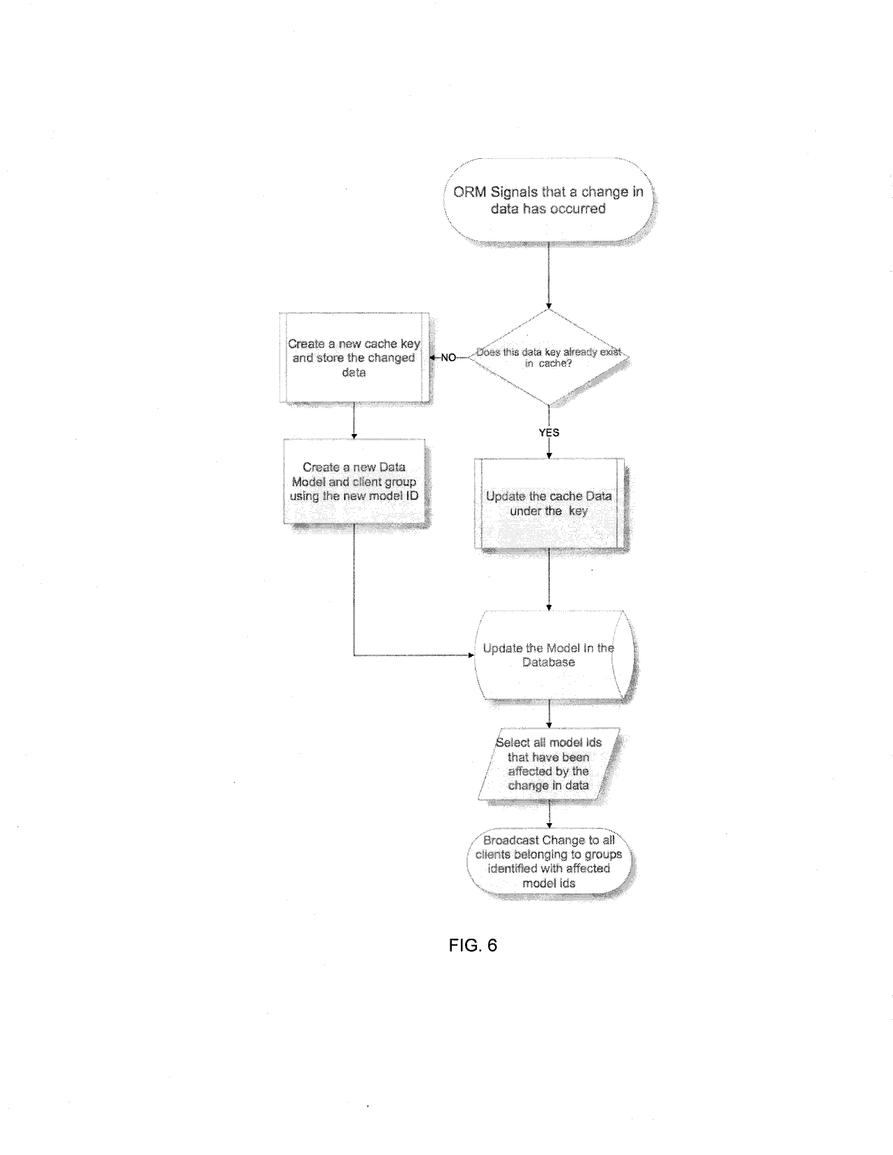

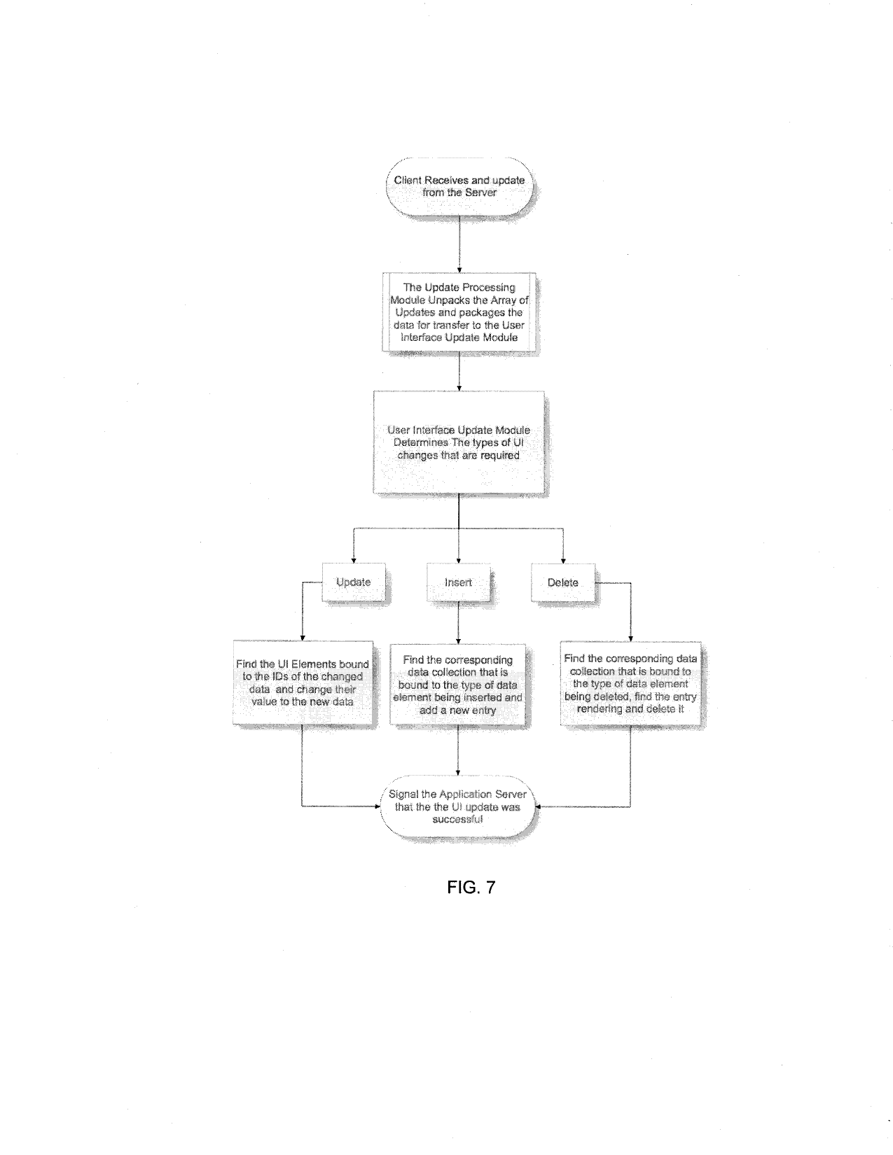

FIGS. 1 to 7 illustrate a system and method for displaying a real-time representation of database records within a graphical user interface running on a plurality of client devices. The client devices are interacting with a message transport module over an open communication channel established between the client's communication module and the message transport module. The open communication channel is intended to enable real-time delivery of push notifications to the client devices from the Application server triggered by changes occurring to the data base records in the source database.

In further detail, the system includes various components:

The plurality of client computers each include a Communication Module that maintains a bi-directional communication channel over the computer network to the Message Transport Server. In some embodiments an extensible messaging and presence protocol (XMPP), Advanced Message Queuing Protocol (AMQP), or a transport layer such as socket.io in conjunctions with Node JS and NOW JS server may be employed as the real-time message brokering and delivery system to and from client devices. Those skilled in the art can adapt systems with similar functionality to act as a message transport and brokering mechanisms for the system described herein. The group messaging functionality of certain implementations of these protocols, Openfire and Ejabberd respectively is of particular interest as it could be utilized to manage large groups of update recipients efficiently and with low latency of message delivery.

An Update Processor Module is a component used in the client application that processes the incoming updates received via Communication module translating them into instructions to update the user interface elements corresponding to a set of data base records affected by the pushed update

A User Interface Update module receives instructions from the Update Processor and executes the update code specific to the platform on which the client user interface is implemented. In one embodiment the framework can be JavaScript running in an Hypertext Markup Language (“HTML”) browser. In this embodiment the Update Processor Module may be implemented as a JavaScript object that can access and modify the Document Object Model asynchronously at run-time. However, any appropriate type of client framework can be used.

A Web Server, which is a module responsible for delivery of static assets such as HTML, JavaScript, image files, text files and any other type of data that is not dynamic in nature but may be required for rendering non-database-driven elements of the graphical user interface

An Application Server that is configured to conduct data base access and modification via an Object Relational Mapping Module (ORM) and maintain a registry of data record models currently active on the connected client devices in accordance with the data records requested by the client device. The ORM also handles user actions that result in data modification or other system events that result in retrieval of database records for delivery to client devices.

A Message Transport Module (MTM) that is responsible for delivery of messages to client devices in real-time. This module establishes a bi-directional connection with the Communication Module on a client device and is used as a message brokering mechanism between a plurality of client devices and the Application Server. Data from the application server is pushed to each of the client devices simultaneously via the MTM. Other functions of the MTM include e message orientation, queuing, routing (including point-to-point and publish-and-subscribe), reliability and security of the message delivery to connected client devices

A Database server that is communicatively coupled with the Object Relational Model Module and configured to centralize data access by the application server and to maintain a subscription registry for models that are currently accessed by the client. When a client first receives a rendering of the database records, its unique identifier is added to a group of addresses that subscribes to updates related to said database records.

A Caching Module responsible for maintaining a set of key-value pairs representing the current state of active database records currently rendered on said client devices. The Caching module is configured to provide fast access to rendered data without the need of making any additional queries to the database.

In some aspects, the system may also involve or include a plurality of client applications that creates a rendering of one or more database records or fields. In a particular embodiment where the client device is a web browser, the client makes an HTTP request to the application server to render a web page that is a rendering of a set of database records contained inside uniquely identified user interface containers; the unique attribute allows the update processor to identify which enclosed fields relate to a particular data record. In one embodiment an HTML “rel” attribute is used to identify an HTML element's relationship with a particular database record, such that this relationship can be later invoked to facilitate an update of the data representation of this record inside all client user interfaces. Such a client could be a web browser or a compiled application with custom GUI display mechanism or other appropriate display system.

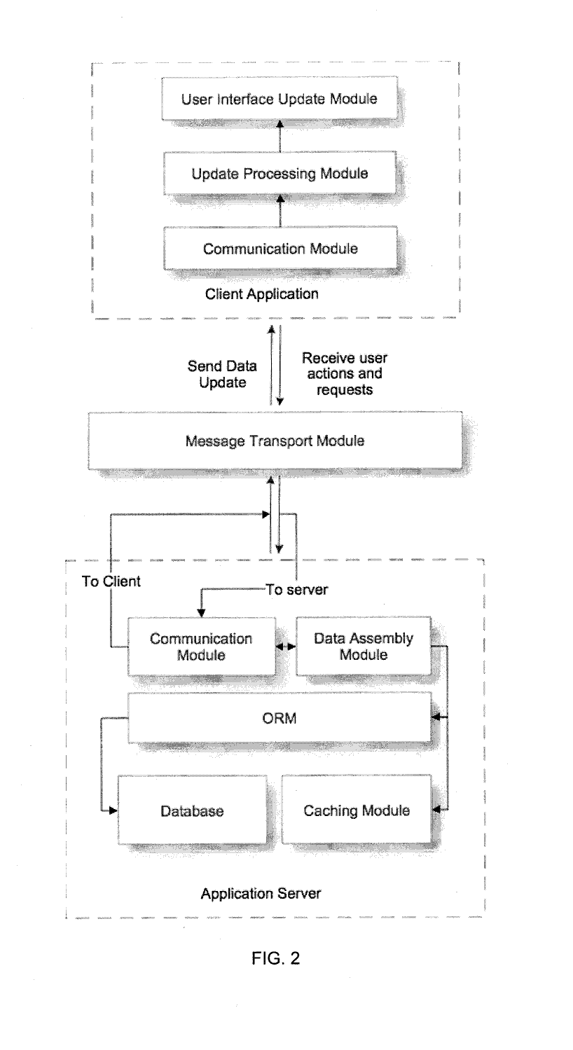

In one embodiment, generally shown in FIG. 2, where the client application is accessed via a browser, the browser makes the request to the web server and receives the initial rendering of a page consisting of database records in their current state as well as executable code for the initialization of all modules residing on the client. The web server passes the request to the application server which renders the initial page along with a set of instructions for the client application to establish a bi-directional communication channel using the Communication module. Upon initiation by a client application, a channel is created between the client computer and the Message Transport Module. Once the channel is established, a session with the application server is initiated by the Communication module on behalf of the client computer. The web client makes the request to the application server to initiate the data session. The web server responds with the initial rendering of database records in their current state.

On failure to generate a bi-directional connection—for example in the case of a text-based/outdated browser or a search spider—the system/method can be configured to fall back to the traditional method of traversing the site pages using the Web Server module over HTTP. This hybrid state allows any static page to be converted to bi-directional access over the framework with only basic modifications—e.g. including a javascript file at the top of the page.

Once the channel is established, each requesting client device is authenticated and thereafter authorized to receive pushed updates from the application server via the Message Transport Module. Authorized client computers establish channels with the communication server so as to initiate the ongoing session. The unique identifier of each client session is stored in the Message Transport Module to form groups of client identifiers that subscribe to the data models that the client has rendered during the initial request. For example if the client renders a particular database query the client's identifier would be stored in a group of client addresses identified by the data query itself. In some embodiments where the query language used is SQL, then the entire SQL statement can be used as an identifier for a particular data model. Each time a new client tries to access the same query, its unique identifier is stored in the Caching module under the key belonging to the requested data model. If the model does not yet exist the system creates a new key within the caching module and stores the requesting client's identifier in a new group residing on the Message Transport Module

When data base records are changed via the ORM module residing on the application server, the Caching Module is queried using the key representing the affected database query. The Caching Module returns list of data models and their respective filters that have requested data from that database row or a set of database rows. Once a list of Model identifiers is compiled, it is checked for duplicate values and the resulting list of unique model identifiers is stored in an array. Application Server transfers this clean list of affected model IDs to the Message Transport Module which delivers the message to all subscribed client devices.

When a user takes an action that updates, deletes or inserts data—either by submitting a form, clicking a button or interacting with any data-bound user interface element, the action is first passed to the Communication Module that transfers the action request to the application server via the Message Transport Module. All actions within the described system are made through textual messages that are delivered to the Application Server, which in turn performs the requested manipulation of data records and then initiates the transport of the necessary data updates to the client devices. If the user session results in a request of new data base records, the client's unique identifier is passed on to the Message Transport Module to be added to the corresponding client group that represents all the current subscribers to the data models that the client has requested during this request.

Once the Application Server has received the request, it routes it to the appropriate database function in the ORM module. The ORM also handles some early-stage cache manipulation logic immediately following committing the query/transaction to the database. The ORM builds an array of the updated information. As an example, this array may store the contents of the DB row that was just inserted/updated. In the case of a delete, it identifies the row that was deleted.

The data array is then passed to the Caching Module and is stored there for later retrieval by the Application Server. The Application server performs a comparison of the new record against its previous state and notifies the ORM module. The ORM module then calls the relevant Caching Module functions to determine which clients require the delivery of new data. The ORM passes the list of models to the Application Server which packages the data for transport and instructs the Transport Module to deliver the packaged data updates to all groups of client devices identified by the models provided by the ORM.

The message is received by client-side Communication Module that is monitoring the bi-directional communication channel. The CM passes the contents of the message to the Update Processing Module which interprets the various payload instructions and passes them on to user interface manipulation module. The User Interface update module invokes the corresponding manipulation commands are invoked to update page sections with the new information as follows:

If the command is an insert or a delete, a row update instruction is invoked. If the command is an update, then a cell update instruction is invoked.

The User Interface update module identifies the targets of updates based on unique parameters that tie the presentation layer elements and containers to active data models data from the ORM. Specifically data that would be PUSH-updated to users when they are changed.

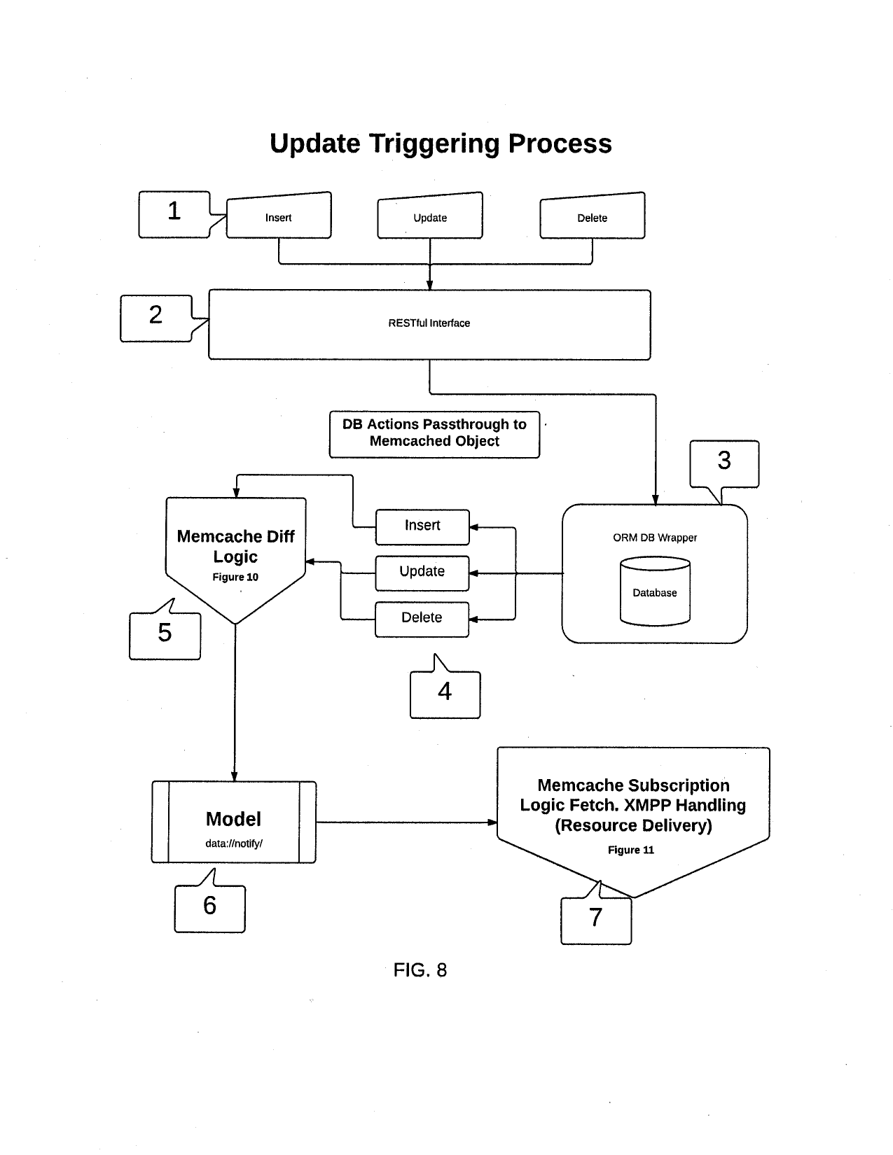

The following section and FIGS. 8-13 describe a particular example implementation of a system and method for updating data as described herein.

### Update Triggering Process (FIG. 8)

When a user takes an action that updates, deletes or inserts data[1]—either by submitting a form, clicking a button or interacting with any data-bound front-end element, it first hits the RESTful interface[2]. All actions within the framework as made through proprietary REST1 calls. As the framework calls all independent resources using uniform resource identifiers (URIs), there is an externally accessible “internal” calling structure to provide ease of segmentation, access control and recall.

Once the REST processor has parsed the request, it routes it to the proper database function in the ORM2 wrapper[3]. In this example framework, the ORM also handles some early-stage cache manipulation logic immediately following committing the query/transaction to the DB. The ORM quickly builds an array of the updated information[4]. This array stores the full contents of the DB row that was just inserted/updated. In the case of a delete, it identifies the row that was deleted.

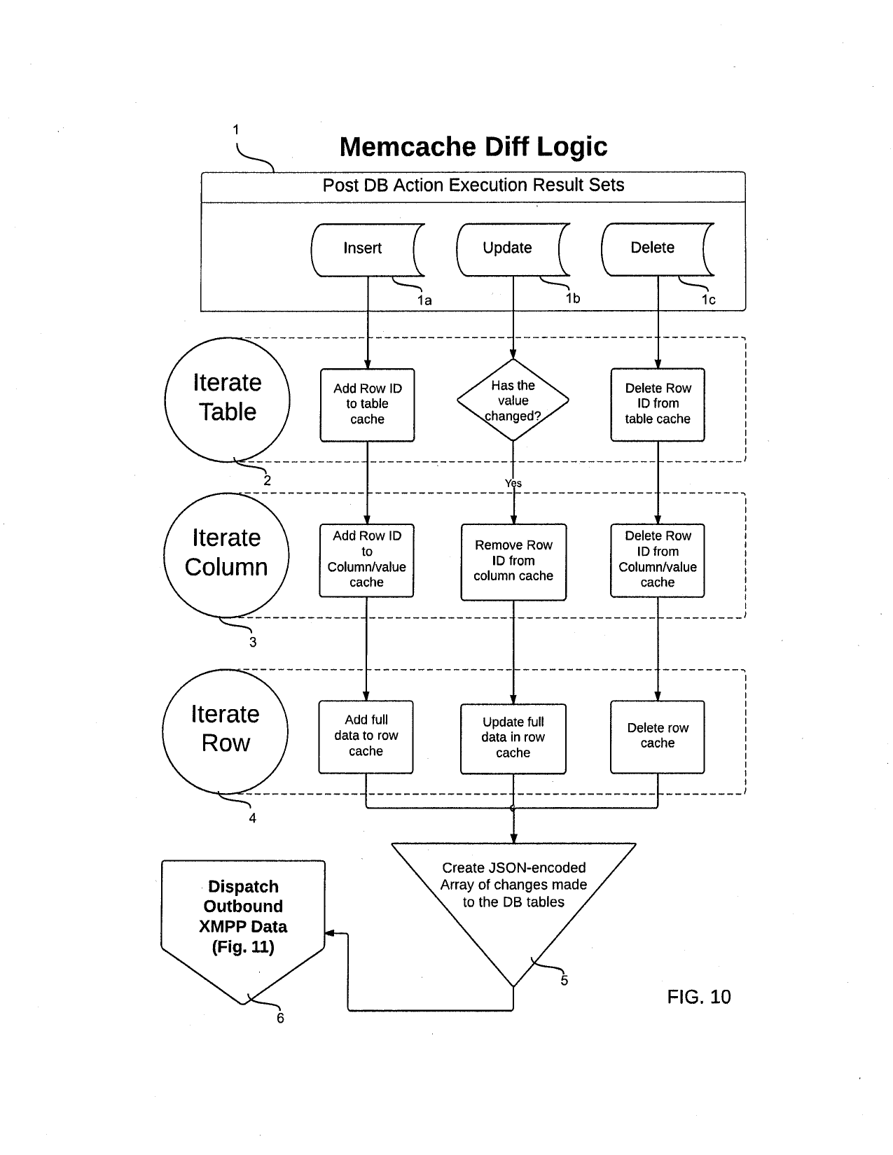

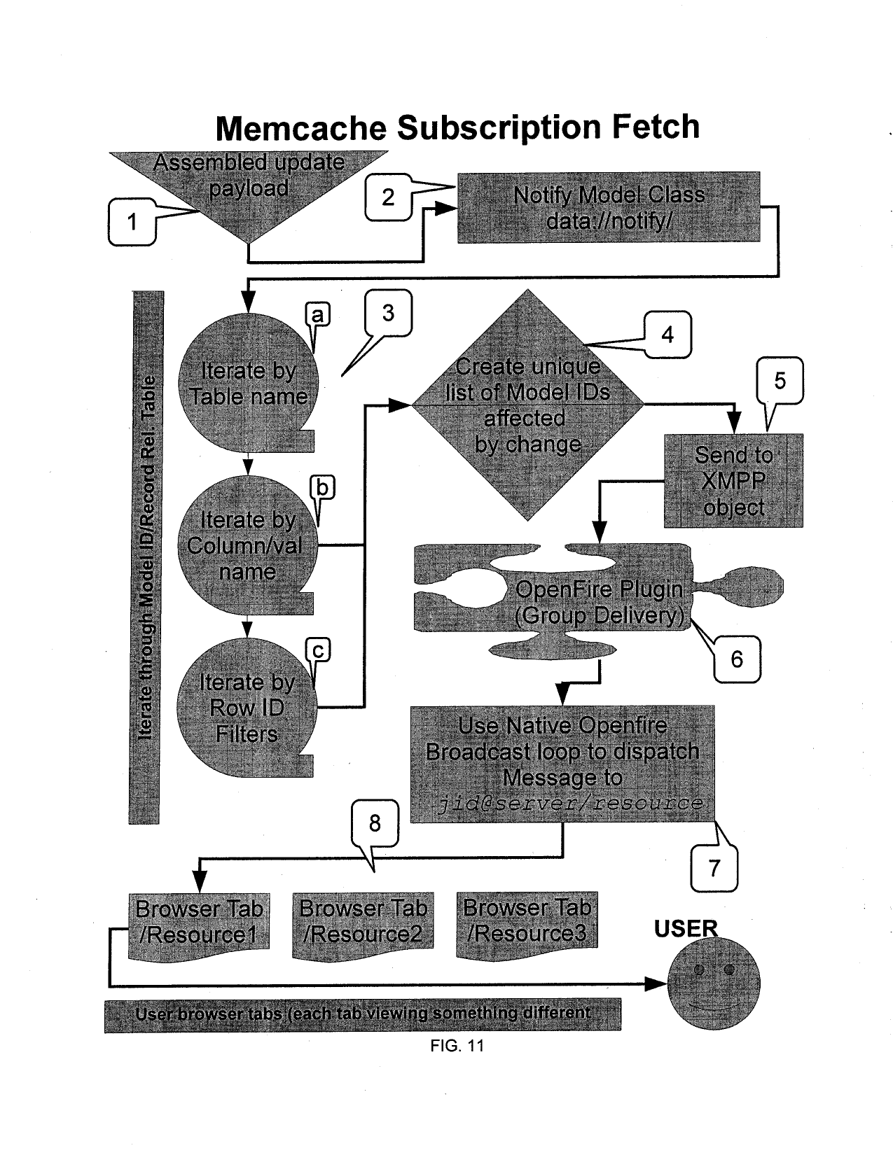

The data array is then passed to the Memcached3 interface and handling class[5 & FIG. 10] which does a fast in-depth analysis/comparison of the new record against its previous state and notifies the Model[6] class through it's REST protocol (data://). The Model then calls the relevant Memcache functions to determine which visitors need to be shown the updated data[7 & FIG. 11].

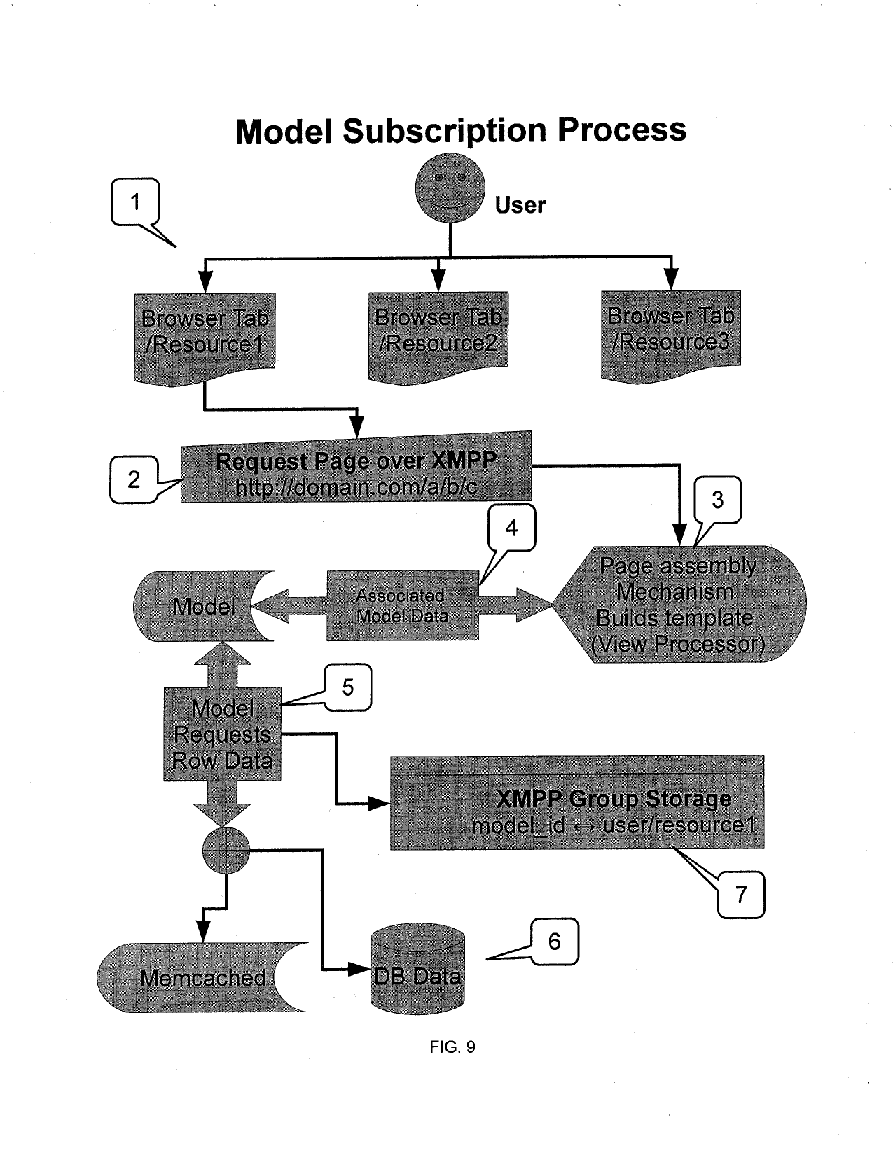

Model Subscription Process (FIG. 9)

In order for the Data Handling System to “know” which user to push an update to, it has to build a subscription relationship between the visitor's session and the model that requested its data. The visitor will have n browser tabs open towards the framework[1]. Each tab is logged into the XMPP4 server with a unique resource5 name to allow targeting of the push notification.

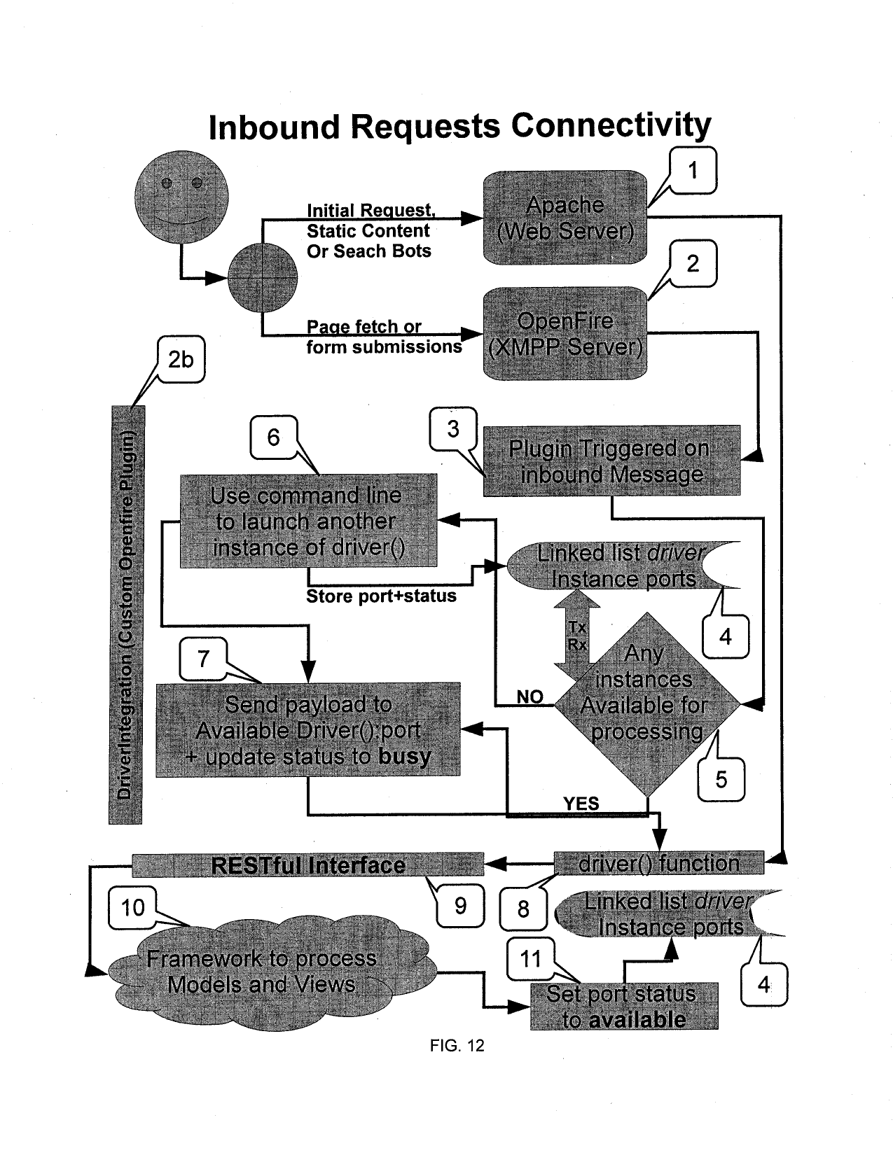

When a tab makes a request to a page using a URL6 scheme as a browser request or through a Javascript XMPP client[2 & FIG. 12] or a native HTML5 socket client such as socket.io, the controller routing the logic eventually reaches the “Page Assembly” mechanism's view processor[3] which is responsible for displaying the data in a properly formatted manner. The View processor makes a request for the data through the Model[4]. The Model is a class that is responsible for the accounting and logic behind data requests[5] made to the framework's various data sources.

In order to speed up requests to physical data sources, previously fetched data is stored in volatile memory using the memcached service[6]. When a Model makes a request for data, it first checks to see if the data is available in memcached before diverting the request to the physical storage (DB).

When a request is completed, the model subscribes the requesting user to the XMPP Group Storage[7] or an alternative group storage mechanism implemented as a layer on top of socket.io for example Now.js. This storage mechanism is a modification of the OpenFire server's Group Subscription feature. This extends user-to-group subscriptions to include unique resources, allowing an update to be pushed directly to a browser tab.

Memcached Differencing Logic (FIG. 10)

After the ORM has finished writing the requested changes to the database, it forwards an updated array of the changed record values [1] to the memcached handler class' differencing logic engine. This is a short list of rule sets that are applied against the cached and updated versions of the database row records. There are 3 root transactions that the ORM can run against the affected database tables.

[1a] When an insert payload is encountered, the engine automatically adds the row id of the payload to the “table” cache[2]. This is the cache that keeps a list of all unique row identifiers held within a table. It acts as a volatile central lookup lost for each table that the ORM is aware of.

The engine then iterates through the columns of the table row data and generates a name-to-value relationship for each. These are the filter results. If a SELECT query has a “WHERE” clause modifier[3], the result set would have IDs registered in this list. If there is a related filter for any of the columns in this row, the current ID will be added to it.

Finally, a cache gets created for the row data so subsequent requests aren't made to the DB and can be requested from the quicker, volatile cache instead[4]. A record is saved of the new row to transmit to the user VIA XMPP [5].

[1b] When an update payload is encountered, the engine compares the difference between the old data array and the new data array. It then iterates through the changed columns of the new (added) row data and old (removed) row data and generates a name-to-value relationship for each. If there is a related filter for any of the columns in this row, the current ID will be added/removed from it depending on which differenced array the data resides in[3].

Finally, a cache gets update for the row data so subsequent requests aren't made to the DB[4].

It merges the old (removed) and new (added) differenced results into a configuration array that can be sent to the visitor VIA XMPP [5].

[1c] When a delete payload is encountered, the engine automatically deletes the row id of the payload from the “table” cache[2].

The engine then iterates through the columns of the table row data and generates a name-to-value relationship for each. If there is a related filter for any of the columns in this row, the current ID will be deleted from it[3].

Finally, the row cache gets destroyed/invalidated [4]. A small array is created with the table name and unique row ID to be sent to the user to indicate the record has been deleted[5].

[6] As a final step, the JSON-encoded arrays created in step[5] are forwarded to the XMPP processor via the Model to dispatch the update to the visitor [FIG. 11].

Model Subscription Fetch (FIG. 11)

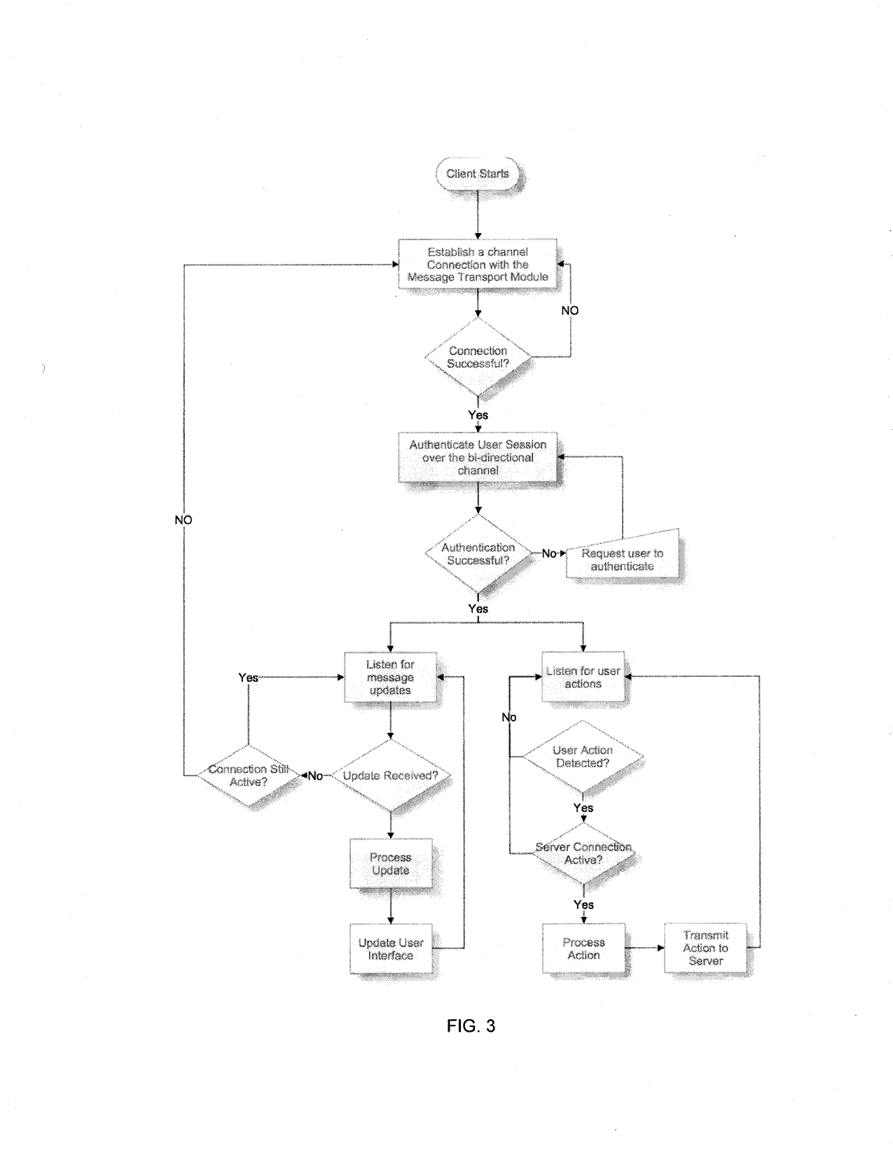

Once the framework has compiled an array that describes exactly what has changed in the data-bound table[1], it sends the information over to the model for visitor notification via the data://notify/ RESTful URI[2]. This URI triggers the Model class' subscription fetching engine which iterates through various Model ID-to-Record relationship engine[3].

[3a] First off, the engine checks to see if there are any models bound to the specific table the modification took place in. If this initial check fails, the Subscription fetching engine returns without taking any further action.

[3b] At the next stage, the engine does column-to-value lookups as it did in FIG. 3. This time, evaluating against a cache of model IDs and their relationships to queries.

[3c] Lastly, a reverse lookup is made against the unique row ID of the updated model to determine of there are any models specifically targeting the contents of a record from the table.

Once a list of all Model IDs is compiled, it is checked for duplicate values and the resulting clean list is stored in an array[4]. This clean list of affected model IDs is transferred to the XMPP processing object via the (xmpp://group_put) URI. This list is sent to the OpenfireServer using the group_id@delivery.<domain>.com URI. The subdomain triggers the proprietary OpenFire Group Broadcast plugin. This plugin is based on the OpenFire Broadcast plugin with modifications made to support sending data targeting an XMPP /resource instead of just a user. This ensures that the specific browser tab that requires an update gets the push notification.

Inbound Requests Connectivity (FIG. 12)

When a visitor accesses an AppOnFire-enabled site, requests are split into two categories; HTTP Requests[1] and XMPP Requests[2].

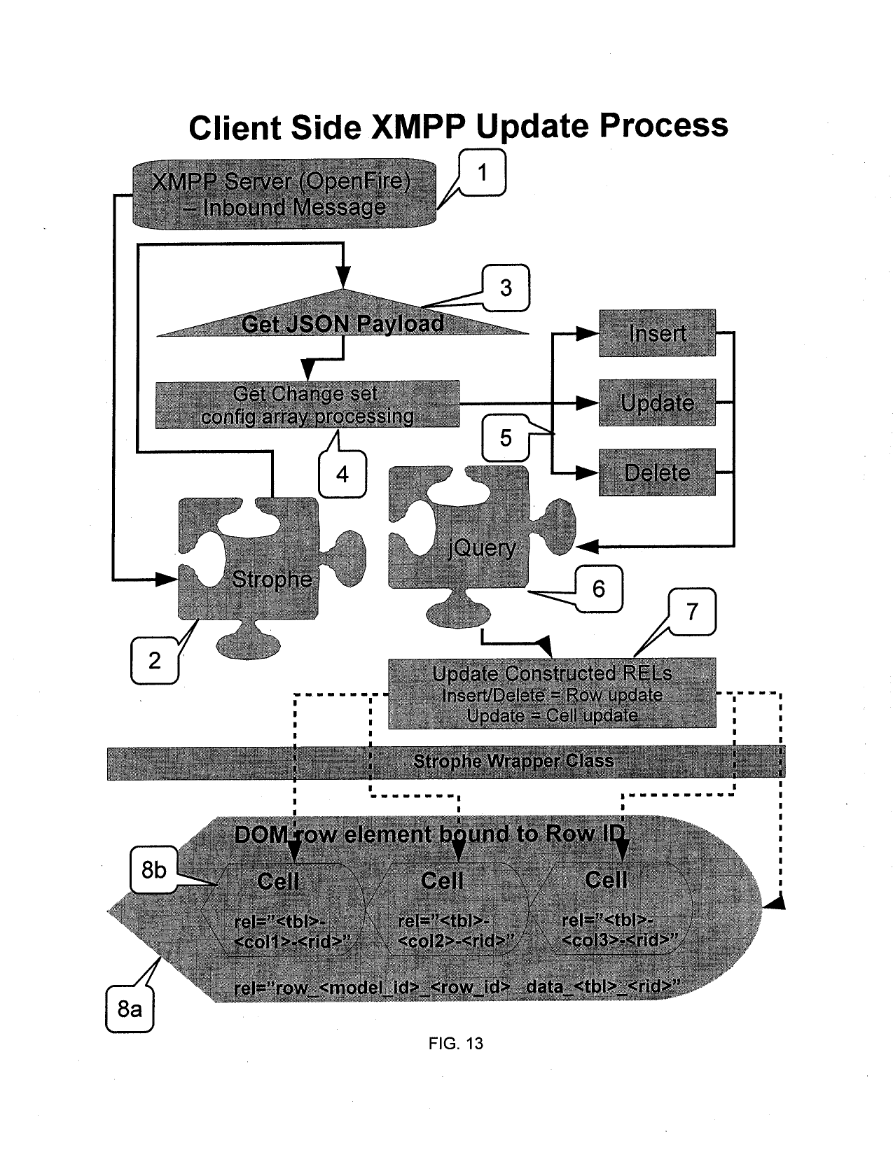

When a user accesses the site for the first time or retrieves static content (e.g. an image, stylesheet, javascript file, etc), the requests and response are made over the standard HTTP protocol[1]. In the initial request stage, the web server component provides the process bootstrapping files[FIG. 13] which include the XMPP Client (StropheJS)7, the XMPP Wrapper Class and jQuery8. The bootstrapping files enable the Real-time interactivity. They also kick-start a parasitic process that can enable AppOnFire interactivity and push updates on an arbitrary static page. If a browser doesn't support javascript or a search bot sees the site, all requests will act as initial requests over classic HTTP.

Once the static components of a page have loaded and the parasitic process has enabled the bi-directional communication component (e.g. BOSH9, WebSockets10), any links that are clicked on are diverted through the XMPP Client's bi-directional channel instead[2].

[3] The inbound request to the framework first hits the XMPP server[2b] which passes the message to the custom DriverIntegration plugin. This starts a chain of process management tasks:

[4] Within the scope of the plugin, and globally accessible from all threads, there is a linked list array comprising a list of all the port numbers of processing daemons. Each port belongs to a dedicated command processing daemon [also known as the driver]. This keeps a list of all allocated instances as well as their current processing status; “busy” or “available”.

[5] The plugin makes a request for the next available instance for processing, if the number of available processes are low or zero, the plugin will initiate a command-line call to initiate a customizable number of processing nodes. It will then store the new port numbers along with their status on the global linked-list[4].

[7] Finally, the plugin will send the request and payload to the driver daemon with the port and updates the status to busy.

[8] This is where the processing of an XMPP request converges with the processing of HTTP request. The driver function/process passes the RESTful URI which can take the form of a proprietary URI construct or a standard http:// URL to the RESTful Interface[9]. Along with the URI, it pushes through any extra parameters, arrays, JSON or browser configuration parameters that came along with it.

[9] The RESTful Interface is a controller that determines with class and/or function to activate to fulfill the URI request.

[10] Once the RESTful interface determines where the request should be sent, processing enters the framework where processing continues[FIG. 8-11]. When the framework returns after processing, the status of the currently active port is set to “available” in the linked-list of driver instance ports[4].

Client Side XMPP Update Process (FIG. 13)

[1] Updates returned from the data handling system are dispatched to the visitor by the XMPP Server. The message is received by client-side Javascript library that is monitoring the bi-directional communication channel, which is the StropheJS client library. This library passes the contents of the message, which are JSON-encoded payload[3] generated by the framework [FIG. 10] to the configuration processing loop[4].

[5] The various payload instructions are interpreted individually and jQuery HTML DOM manipulation commands[6] are invoked to update page sections with the new information as follows:

[7] If the command is an insert or a delete, a row update instruction is invoked. If the command is an update, then a cell update instruction is invoked.

The difference between a row update and a cell update, can be seen in the DOM layout of how the data is written.

In order to create content IDs [8a,8b] that can be used to identify the targets of updates, the display engine (presentation layer) assigns the HTML REL parameter to elements that contain data from the ORM. Specifically data that would be PUSH-updated to users when they are changed. See the Structure Definitions section for more information.

In the preceding description, for purposes of explanation, numerous details are set forth in order to provide a thorough understanding of the embodiments. However, it will be apparent to one skilled in the art that these specific details may not be required. In other instances, well-known structures are shown in block diagram form in order not to obscure the understanding.

The above-described embodiments are intended to be examples only. Alterations, modifications and variations can be effected to the particular embodiments by those of skill in the art without departing from the scope. In particular, it will be understood that the embodiments may include elements that are computer program code that can be executed on a computing device and may be embodied in a physical computer media that contains instructions for execution by a computing device.

1. A system and method for updating data as both generally and specifically described herein.
